(19) United States
(12) Patent Application Publication
(10) Pub. No.: US 2026/0107263 A1
(43) Pub. Date: Apr. 16, 2026

(54) METHODS AND APPARATUSES FOR SIDELINK BEAM MANAGEMENT

(71) Applicant: TOYOTA JIDOSHA KABUSHIKI KAISHA, Toyota-shi, Aichi-ken (JP)

(72) Inventors: Ling YU, Kauniainen (FI); Daniel MEDINA, Munchen (DE); Torsten WILDSCHEK, Gloucester (GB); Nuno KIILERICH PRATAS, Gistrup (DK); Jun TAN, Glenview, IL (US); Takayuki SHIMIZU, Mountain View, CA (US); John KENNEY, Mountain View, CA (US)

(73) Assignee: TOYOTA JIDOSHA KABUSHIKI KAISHA, Toyota-shi, Aichi-ken (JP)

(21) Appl. No.: 19/116,616

(22) PCT Filed: Sep. 15, 2023
(86) PCT No.: PCT/JP2023/033700

§ 371 Date: Mar. 28, 2025

Related U.S. Application Data
(60) Provisional application No. 63/377,428, filed on Sep. 28, 2022.

(51) Int. Cl. H04W 72/044; H04W 72/25

(52) U.S. Cl. CPC H04W 72/044; H04W 72/25

(57) ABSTRACT

A method includes: configuring, by a first user equipment (UE), one or more carriers within a first frequency range, at least one of the one or more carriers including an indication indicating sidelink beam management information associated with one or more beams within a second frequency range; and transmitting, to a second UE, the configured one or more carriers within the first frequency range so as to allow the second UE to obtain the indication.

### CROSS-REFERENCE TO RELATED PATENT APPLICATION

This application claims the benefit of U.S. Provisional Application No. 63/377,428, filed on Sep. 28, 2022, entitled “FR1 FACILITATED BEAMFORMED IN SL FR2 OPERATION,” the entirety of which is incorporated by reference herein.

### TECHNICAL FIELD

Apparatuses and methods consistent with the present disclosure relate generally to communications, more specifically, methods, systems, and devices for sidelink beam management in a sidelink communication.

### BACKGROUND ART

Beam-based communications generally require alignment of beams. For example, in a beam-based sidelink communication case, a transmitter (Tx) beam from a user equipment (UE) and a receiver (Rx) beam from another UE need to be aligned. For another example, in a beam-based downlink/uplink communication, a beam from a base station and a beam from a UE need to be aligned. Beam alignment usually involves beam searching for the best beam. For example, a UE in communication with a base station (which is usually in a fixed position) may receive reference signals from the base station and detect the best beam based on the measurement of the reference signal. However, in a sidelink communication, it is difficult for a UE to know beforehand all relevant UE(s) providing relevant signals, especially when there are many moving UEs in proximity. This means that the UE needs to scan or search for all possible reference signals in proximity, which may consume a lot of UE energy and increase operational overhead. Improved systems and methods for beam management for beam-based sidelink communications are desired.

### SUMMARY OF INVENTION

According to some embodiments of the present disclosure, there is provided a first UE for providing sidelink beam management information. The first UE includes a memory storing an instruction; and a processor configured to execute the instruction stored in the memory to: configure one or more carriers within a first frequency range, at least one of the one or more carriers including an indication indicating sidelink beam management information associated with one or more beams within a second frequency range; and transmit, to a second UE, the configured one or more carriers within the first frequency range so as to allow the second UE to obtain the indication.

According to some embodiments of the present disclosure, there is provided a second UE for receiving sidelink beam management information. The second UE includes a memory storing an instruction; and a processor configured to execute the instruction stored in the memory to: receive, from a first UE, one or more carriers within a first frequency range, at least one of the one or more carriers including an indication indicating sidelink beam management information associated with one or more beams within a second frequency range; identify, based on the indication, the sidelink beam management information associated with the one or more beams within the second frequency range; and adjust, based on the sidelink beam management information, a sidelink communication associated with the one or more beams within the second frequency range.

According to some embodiments of the present disclosure, there is provided a method for providing sidelink beam management information. The method includes configuring, by a first UE, one or more carriers within a first frequency range, at least one of the one or more carriers including an indication indicating sidelink beam management information associated with one or more beams within a second frequency range; and transmitting, to a second UE, the configured one or more carriers within the first frequency range so as to allow the second UE to obtain the indication.

According to some embodiments of the present disclosure, there is provided a method for receiving sidelink beam management information. The method includes receiving, by a second UE, from a first UE, one or more carriers within a first frequency range, at least one of the one or more carriers including an indication indicating sidelink beam management information associated with one or more beams within a second frequency range; identifying, by the second UE, based on the indication, the sidelink beam management information associated with the one or more beams within the second frequency range; and adjusting, based on the sidelink beam management information, a sidelink communication associated with the one or more beams within the second frequency range.

According to some embodiments of the present disclosure, there is provided a non-transitory computer-readable medium storing instructions that are executable by one or more processors of a first UE in a sidelink communication network to perform a method. The method includes configuring one or more carriers within a first frequency range, at least one of the one or more carriers including an indication indicating sidelink beam management information associated with one or more beams within a second frequency range; and transmitting, to a second UE, the configured one or more carriers within the first frequency range so as to allow the second UE to obtain the indication.

According to some embodiments of the present disclosure, there is provided a non-transitory computer-readable medium storing instructions that are executable by one or more processors of a second UE in a sidelink communication network to perform a method. The method includes receiving, from a first UE, one or more carriers within a first frequency range, at least one of the one or more carriers including an indication indicating sidelink beam management information associated with one or more beams within a second frequency range; identifying, based on the indication, the sidelink beam management information associated with the one or more beams within the second frequency range; and adjusting, based on the sidelink beam management information, a sidelink communication associated with the one or more beams within the second frequency range.

### BRIEF DESCRIPTION OF DRAWINGS

FIG. 1 is a schematic diagram illustrating a beam alignment procedure between a UE and a base station, consistent with some embodiments of the present disclosure.

FIG. 2 is a schematic diagram illustrating a sidelink beam management scheme, consistent with some embodiments of the present disclosure.

FIG. 3 is a flow chart illustrating a method for providing sidelink beam management information, consistent with some embodiments of the present disclosure.

FIG. 4 is a flow chart illustrating a method for receiving sidelink beam management information, consistent with some embodiments of the present disclosure.

FIG. 5 is a block diagram of a UE, consistent with some embodiments of the present disclosure.

### DESCRIPTION OF EMBODIMENTS

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the present disclosure. Instead, they are merely examples of systems, apparatuses, and methods consistent with aspects related to the present disclosure as recited in the appended claims.

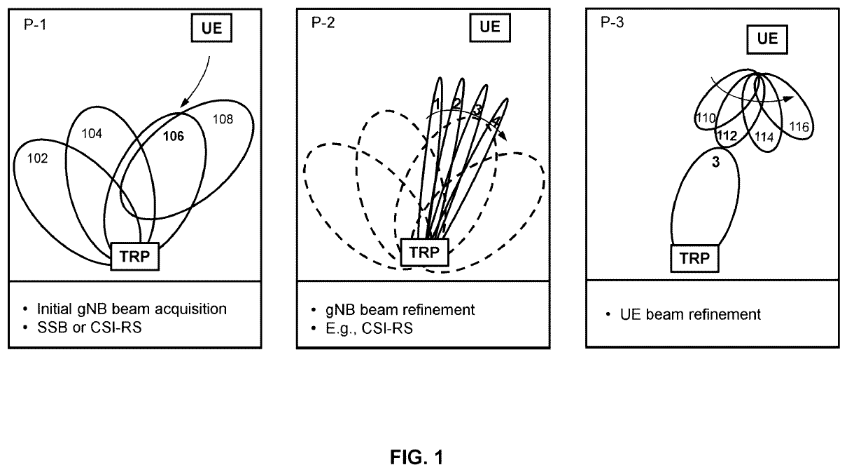

FIG. 1 is a schematic diagram illustrating a beam alignment procedure between a UE and a base station, consistent with some embodiments of the present disclosure. Referring to FIG. 1, a UE communicates with a base station (e.g., gNB) via a transmission and reception point (TRP) using high frequency beams (e.g., FR2). In the present disclosure, FR2 is defined as two frequency sub-ranges: FR2-1 from 24250 to 52600 MHz and FR2-2 from 52600 to 71000 MHZ (including the millimeter wave spectrum). The alignment of a beam from the base station and a beam from the UE is performed using a four-step procedure. At a first step, the base station transmits probe signals 102, 104, 106, and 108 in different directions using different Tx beams (P-1 of FIG. 1). The probe signals may be synchronization signal (SS)/physical broadcast channel (PBCH) block (SSB) or channel state information-reference signal (CSI-RS). At a second step, the UE provides feedback on the best beam (106) from the base station (P-1 of FIG. 1), and the base station transmits signals (1, 2, 3, and 4 in P-2) using the best beam 106 (P-2 of FIG. 1). The signals 1, 2, 3, and 4 in P-2 may be CSI-RS signals. After further refinement using the signals 1, 2, 3, and 4, the base station identifies beam 3 (P-3 of FIG. 1) as the best beam. At a third step, the UE transmits probe signals 110, 112, 114, and 116 in different directions using different Tx beam configurations (P-3 of FIG. 1). At a fourth step, the base station provides feedback on the best beam (112) from the UE (P-3 of FIG. 1). As shown in P-3, beam 112 from the UE and the beam 3 from the base station are aligned. In some embodiments, to facilitate the UE to detect and search for the best beam based on SSB measurement in the initial beam acquisition, the base station may provide SSB related information and/or configurations via radio resource control (RRC) parameters in a master information block (MIB) or a system information block (SIB).

At least some embodiments of the present disclosure are directed to sidelink beam alignment in a sidelink communication. For example, in an embodiment, a beam alignment procedure similar to the above-noted procedure in FIG. 1 is used in a sidelink beam alignment. In a sidelink communication, a UE may have one or more peer UEs in proximity that may be relevant UEs. The UE may not know existence of the relevant peer UEs beforehand. The UE may perform a scan and/or search for all possible SSB reference signals and any SSB transmission resources related to sidelink FR2 beams in order to find the best beam of the relevant UEs in proximity. This may cause issues, for example, consuming the UE's energy and prolonging the initial beam acquisition process. In some embodiments, the above-noted issues are alleviated by fixing the SSB transmission resources to certain resources that are known to the UE.

At least some embodiments of the present disclosure provide enhanced sidelink beam alignment using low frequency band signals to provide beam management information relevant for high frequency beams for beam alignment, thereby reducing operational overhead and increasing efficiency of the sidelink communication. For example, some embodiments of the present disclosure are directed to the sidelink beam alignment in which sidelink transmissions at low frequency bands (e.g., FR1) using an omnidirectional antenna or wide directional antenna provide the relevant beam management information for high frequency band beams (e.g., FR2) to facilitate the beam search or tracking of a UE. In the present disclosure, FR1 is defined as a frequency range of from 410 to 7125 MHZ (including the sub-6 GHz spectrum). In some embodiments, a high frequency sidelink operation has an associated operation in a low-frequency band, and thus the high-frequency sidelink operation is a non-standalone (NSA) sidelink (SL) operation (e.g., NSA FR2 SL operation).

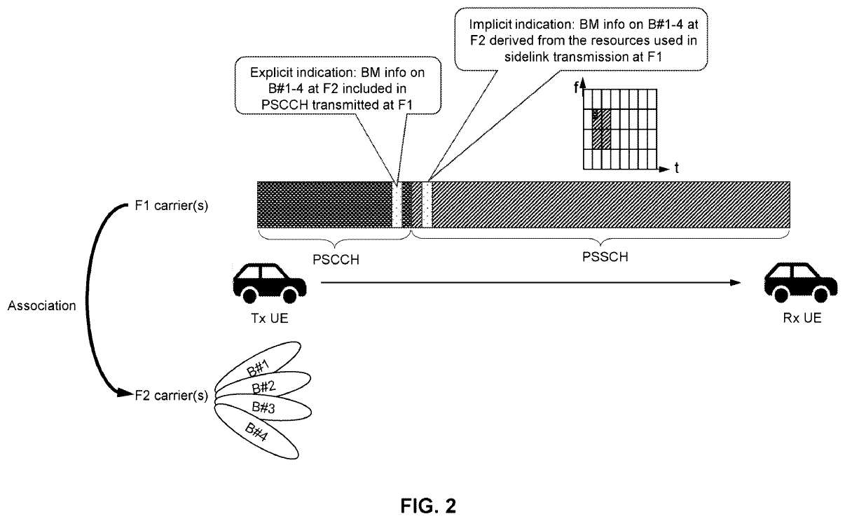

FIG. 2 is a schematic diagram illustrating a sidelink beam management scheme, consistent with some embodiments of the present disclosure. Referring to FIG. 2, a sidelink communication system includes a Tx UE and an Rx UE that communicate with each other. For example, the Tx UE and the Rx UE may communicate using low frequency (e.g., FR1) sidelink signals and/or high frequency (e.g., FR2) sidelink signals. In some embodiments, the low frequency sidelink signals are based on a first radio access technology (RAT) and the high frequency sidelink signals are based on a second RAT. The first RAT and the second RAT may be the same or different from one another. In some embodiments, the first RAT is long term evolution (LTE) and the second RAT is new radio (NR). In some embodiments, both the first RAT and the second RAT are NR.

In some embodiments, at the Tx UE, a low frequency resource pool is associated with a high frequency resource pool. For example, as shown in FIG. 2, the Tx UE may configure one or more carriers within a first frequency range (F1 carrier(s)). The first frequency range may be any low frequency range (e.g., FR1). The Tx UE may configure the F1 carrier(s) such that at least one of the F1 carrier(s) includes an indication indicating sidelink beam management information associated with one or more carriers within a second frequency range (F2 carrier(s)). The second frequency range may be any high frequency range (e.g., FR2). The F2 carrier(s) may correspond to one or more beams, for example, four beams (B#1 to B#4) as shown in FIG. 2.

In some embodiments, the indication indicating sidelink beam management information at the second frequency range (e.g., FR2) is an explicit indication. For example, in some embodiments, as shown in FIG. 2, the sidelink beam management information (BM info) associated with the F2 carrier(s) is indicated explicitly in the PSCCH or SCI of a sidelink signal transmitted to the Rx UE at the first frequency (e.g., FR1) via physical layer. In some embodiments, the indication may be transmitted to the Rx UE via media access control (MAC) control element (CE) at MAC layer, or higher layer information (e.g., network layer, transport layer, or application layer). In some embodiments, the indication may include one or more identifications (IDs) of one or more beam reference signals corresponding to the beams #1 to #4. For example, the indication included in the PSCCH or SCI and transmitted to the Rx UE at the first frequency (e.g., FR1) may include IDs (e.g., 1 to 4) of the beam reference signals that correspond to the beams #1 to #4. In some embodiments, the indication may further include one or more resources to be used for transmission of the beam reference signals corresponding to the beams #1 to #4. The one or more resources may include time resource and/or frequency resource, such as, one or more frames, subframes, slots, channels, subchannels, or resource blocks. Upon receipt of a sidelink signal transmitted from the Tx UE at the first frequency range (e.g., FR1), the Rx UE may obtain the indication indicating sidelink beam management information at the second frequency range (e.g., FR2) by decoding the PSCCH or SCI included in the sidelink signal.

In some embodiments, the beam reference signals corresponding to beams #1 to #4 are transmitted from a plurality of different antennas, or from a plurality of different antenna panels of an antenna. In this case, the indication indicated in the PSCCH or SCI may include an order of transmission of the beam reference signals corresponding to the beams #1 to #4, or an order of the antennas or antenna panels. The order can be an ascending order or descending order. In some embodiments, the indication included in the PSCCH or SCI may further include an indication of directional beam transmission support with or without beam tuning capability. This information can be used by the Rx UE to determine feedback information on beam management.

In some embodiments, for an initial beam alignment, a full list of beam reference signal IDs and corresponding transmission resources may be indicated for beam management. For example, in some embodiments, the Tx UE may configure the F1 carrier(s) before an initial beam alignment. In this case, the indication included in the PSCCH or SCI may include a full list of IDs of the beam reference signals corresponding to the beams #1 to #4, and corresponding resources (time and/or frequency) to be used for transmission of the beam reference signals.

In some embodiments, for beam management after an initial beam alignment, only a portion of a full list of IDs of the beam reference signals corresponding to the beams #1 to #4 (e.g., the adjacent beams information) may be indicated. For example, in some embodiments, the Tx UE may configure the F1 carrier(s) after an initial beam alignment, and the indication included in the PSCCH or SCI may include a partial list of IDs of the beam references signals corresponding to the beams #1 to #4.

In some embodiments, due to ad-hoc nature of sidelink communication, beam management configuration such as beam reference signal(s) and its transmission resources may not be made static. In this case, the Tx UE may select the beam reference signal(s) and transmission resources, while ensuring that the selected beam reference signal(s) and the transmission resource do not interfere (or conflict) with the ones used or selected by other UEs in proximity. For example, in order to mitigate the conflict, the Tx UE may monitor beam management information indicated by other UEs and avoid transmitting the same beam management information.

In some embodiments, the F1 carrier(s) may be a plurality of carriers to be aggregated. In this case, in an embodiment, each of the plurality of carriers may include a different indication indicating different sidelink beam management information. In another embodiment, only one or more specific carriers of the plurality of carriers may include one or more indications indicating sidelink beam management information. The one or more specific carriers may be configured by a network node or pre-configured at the first UE.

In some embodiments, the indication indicating sidelink beam management information at the second frequency range (e.g., FR2) may be an implicit indication. For example, the indication may be implicitly indicated by the resources used for sidelink transmission at the first frequency range (e.g., FR1). For example, as shown in FIG. 2, the indication indicating sidelink beam management information (BM info) at the second frequency range is implicitly indicated by the time and/or frequency resources used for sidelink transmission at the first frequency range (e.g., FR1). For example, in an embodiment, as shown in FIG. 2, the time and/or frequency resources used for sidelink transmission at the first frequency range (e.g., FR1) may correspond to a specific indication indicating sidelink beam management information at the second frequency range (e.g., FR2). A mapping table (rule) may be generated based on the correspondence between the different points in the frequency and/or time resources and the different indications. In this case, based on the mapping table (rule), the Rx UE may derive the indication, such as the sidelink beam reference signal ID(s) and its transmission resources, from the time and/or frequency resources used for the sidelink transmission at the first frequency range. The mapping rule may be configured by a network node, predefined, or pre-configured at the Tx UE and the Rx UE. For example, in an embodiment, in order to ensure that the Tx UE and the Rx UE derive the same beam management information, the mapping rule is configured to both the Tx UE and the Rx UE by a network node, or pre-configured at both the Tx UE and the Rx UE. In some embodiments, the mapping rule may be designed to allow different sidelink Tx UEs using different sets of sidelink resources for their sidelink transmission at the first frequency range to derive the different beam management information. For example, beam reference signal ID(s) and/or transmission resources information included in different sidelink Tx UEs are different. In this way, the conflict of beam management configuration used by different UEs in proximity can be avoided.

In some embodiments, the sidelink transmission at the first frequency range (e.g., FR1) may include both implicit and explicit indications. For example, in some embodiments, limited explicit information regarding UE capability (e.g., the number of beams, support of beam tuning or not, and antenna configuration) may be included in the SCI of the sidelink transmission at the first frequency range. In some embodiments, the information regarding the UE capability (e.g., the number of beams, support of beam tuning or not, and antenna configuration) may be associated with sidelink resource pool at the first frequency range. For example, different sidelink resource pools at the first frequency range may be configured and associated with the sidelink UEs at the second frequency range that have different antenna capability. In an embodiment, one or more bit indication in sidelink transmission at the first frequency range (e.g., FR1) may be used to indicate that the Tx UE has the capability of using both the first frequency range (e.g., FR1) and the second frequency range (e.g., FR2) for sidelink communication operation, which enables the implicit indication mechanism for sidelink communication at the second frequency range (e.g., FR2).

Upon receipt the indication indicating the sidelink beam management information at the second frequency range, the Rx UE may adjust a sidelink communication associated with the beams within the second frequency range, based on the sidelink beam management information. For example, the Rx UE may adjust the beam alignment based on the beam management information. The Rx UE may also adjust the resources to be used for transmission based on the beam management information. In this way, the beam alignment of the beams at the second frequency range (e.g., FR2) may be facilitated by the indication conveyed at the first frequency range (e.g., FR1), thereby reducing operational overhead in beam alignment.

The methods described in this disclosure can be applied to any sidelink communications, for example, LTE or NR or a future generation (6^{th} generation (6G), 7^{th} generation (7G), or any future generation) sidelink communications. The methods described in this disclosure can also be applied to downlink/uplink communications between a base station and a UE. The methods described in this disclosure can also be applied to other systems, for example, the systems that comply with other standards (e.g., the Institute of Electrical and Electronics Engineers (IEEE) standards).

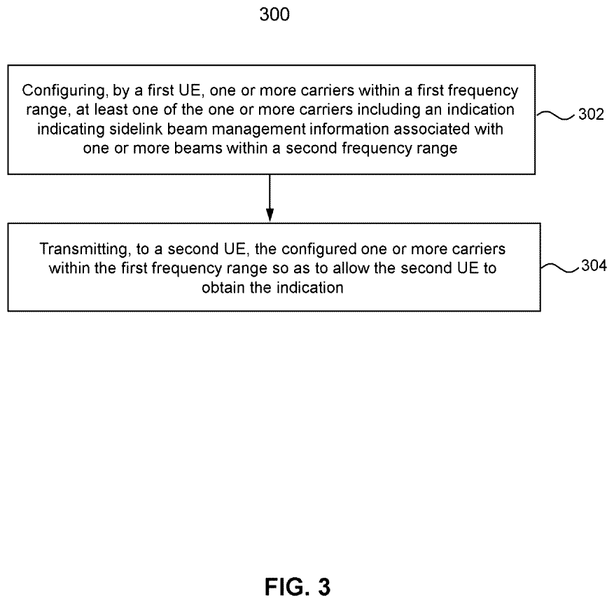

FIG. 3 is a flow chart illustrating a method 300 for providing sidelink beam management information, consistent with some embodiments of the present disclosure. The method 300 may be performed by a Tx UE in a sidelink communication, such as the Tx UE of FIG. 2.

The method 300 includes a step 302 of configuring, by a first UE, one or more carriers within a first frequency range, at least one of the one or more carriers including an indication indicating sidelink beam management information associated with one or more beams within a second frequency range. In an embodiment, the first frequency range is FR1, and the second frequency range is FR2. For example, in this embodiment, the first UE (e.g., the Tx UE of FIG. 2) may configure one or more FR1 carriers including an indication indicating sidelink beam management information associated with one or more FR2 beams. The indication may be an explicit indication or implicit indication, for example, as described above with respect to FIG. 2. In some embodiments, the indication may be transmitted via at least one of SCI at physical layer, MAC CE at MAC layer, or higher layer information.

In some embodiments, the indication may include one or more IDs of one or more beam reference signals corresponding to the one or more beams within the second frequency range. In some embodiments, the indication may further include one or more resources to be used for transmission of the one or more beam reference signals. The one or more resources may include at least one of a time resource (e.g., one or more frames, subframes, slots) or a frequency resource (e.g., one or more channels, subchannels). The one or more resources may also include time-frequency resource (e.g., one or more resource blocks).

In some embodiments, the one or more beams may be a plurality of beams to be transmitted from a plurality of different antennas, or from a plurality of different antenna panels. In this case, the indication may include an order of transmission of at least one of the plurality of beams or the plurality of antenna panels. The order can be an ascending order or a descending order. In some embodiments, the indication may further include an indication of directional beam transmission support with or without beam tuning capability.

In some embodiments, configuring the one or more carriers within the first frequency range may be performed before an initial beam alignment. In this case, the indication may include a full list of IDs of the one or more beam reference signals, and corresponding resources to be used for transmission of the one or more beam reference signals. In some embodiments, configuring the one or more carriers within the first frequency range may be performed after an initial beam alignment. In this case, the indication may include a partial list of IDs of the one or more beam reference signals.

In some embodiments, the indication indicating sidelink beam management information may be an implicit indication that can be derived from one or more resources used for transmission of the one or more carriers based on a mapping rule. The mapping rule may be configured by a network node, pre-configured at the first UE, or pre-defined.

In some embodiments, the one or more carriers within the first frequency range may be a plurality of carriers to be aggregated, and each of the plurality of carriers may include a different indication indicating different sidelink beam management information. In some embodiments, the one or more carriers within a first frequency range may be a plurality of carriers to be aggregated, and one or more specific carriers of the plurality of carriers include one or more indications indicating sidelink beam management information. The one or more specific carriers may be configured by a network node or pre-configured at the first UE.

In some embodiments, the sidelink communications within the first frequency range are based on a first RAT and sidelink communications within the second frequency range are based on a second RAT. The first RAT and the second RAT may be the same or different from one another. In some embodiments, the first RAT is LTE, and the second RAT is NR. In some embodiments, both the first RAT and the second RAT are NR.

The method 300 includes a step 304 of transmitting, to a second UE, the configured one or more carriers within the first frequency range so as to allow the second UE to obtain the indication. For example, the second UE may be an Rx UE in a sidelink communication, such as the Rx UE of FIG. 2.

In some embodiments, the second UE may be a plurality of UEs configured to operate under the second frequency range. In some embodiments, the indication is a first indication, and the first UE may further monitor at least one of the plurality of UEs for transmission of at least one second indication indicating sidelink beam management information. The first indication and the second indication may be the same or different. The first UE may avoid transmission of the first indication, in response to a determination that the first indication and the second indication are identical.

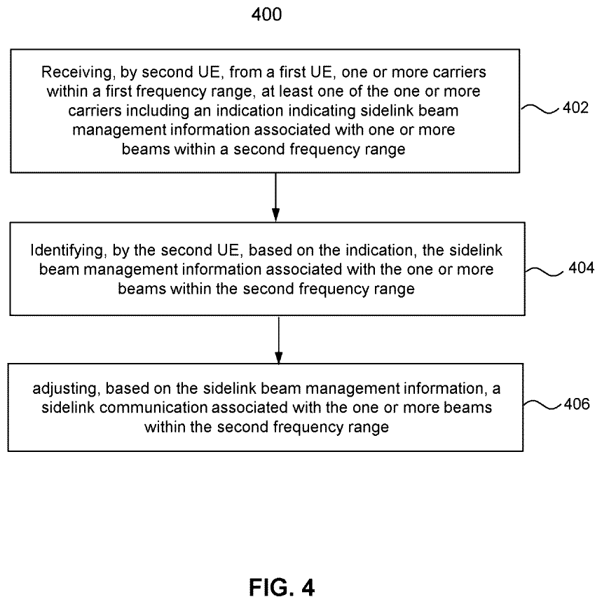

FIG. 4 is a flow chart illustrating a method 400 for receiving sidelink beam management information, consistent with some embodiments of the present disclosure. The method 400 may be performed by an Rx UE in a sidelink communication, such as the Rx UE of FIG. 2.

The method 400 includes a step 402 of receiving, by a second UE, from a first UE, one or more carriers within a first frequency range, at least one of the one or more carriers including an indication indicating sidelink beam management information associated with one or more beams within a second frequency range. For example, the second UE may be an Rx UE in a sidelink communication, such as the Rx UE of FIG. 2, and the first UE may be a Tx UE in a sidelink communication, such as the Tx UE of FIG. 2.

In an embodiment, the first frequency range may be FR1, and the second frequency range may be FR2. For example, in this embodiment, second UE (e.g., the Rx UE of FIG. 2) may receive from the first UE (e.g., the Tx UE of FIG. 2) one or more FR1 carriers including an indication indicating sidelink beam management information associated with one or more FR2 beams. The indication may be an explicit indication or implicit indication, for example, as described above with respect to FIG. 2. In some embodiments, the second UE may receive the indication via at least one of SCI at physical layer, MAC CE at MAC layer, or higher layer information.

In some embodiments, the indication may include one or more IDs of one or more beam reference signals corresponding to the one or more beams within the second frequency range. In some embodiments, the indication may further include one or more resources to be used for transmission of the one or more beam reference signals. The one or more resources may include at least one of a time resource or a frequency resource.

In some embodiments, the one or more beams are a plurality of beams to be transmitted from a plurality of different antennas, or from a plurality of different antenna panels. In this case, the indication may include an order of transmission of at least one of the plurality of beams or the plurality of antenna panels. In some embodiments, the indication may further include an indication of directional beam transmission support with or without beam tuning capability.

In some embodiments, the indication is a first indication, and the second UE may further transmit, to the first UE, a second indication indicating sidelink beam management information. The first indication and the second indication may be the same or different. In some embodiments, the one or more carriers within the first frequency range may be a plurality of carriers to be aggregated, and each of the plurality of carriers may include a different indication indicating different sidelink beam management information.

In some embodiments, the one or more carriers within the first frequency range may be a plurality of carriers to be aggregated, and one or more specific carriers of the plurality of carriers may include one or more indications indicating sidelink beam management information. The one or more specific carriers may be configured by a network node or pre-configured at the second UE.

In some embodiments, the sidelink communications within the first frequency range are based on a first RAT and sidelink communications within the second frequency range are based on a second RAT. The first RAT and the second RAT may be the same or different from one another. In some embodiments, the first RAT is LTE, and the second RAT is NR. In some embodiments, both the first RAT and the second RAT are NR.

The method 400 includes a step 404 of identifying, by the second UE, based on the indication, the sidelink beam management information associated with the one or more beams within the second frequency range.

For example, in some embodiments, the indication is an explicit indication, and the second UE may identify the sidelink beam management information associated with the one or more beams within the second frequency range by decoding the SCI received from the first UE at the first frequency range. In some embodiments, the indication is an implicit indication, and the second UE may derive, from one or more resources used for transmission of the one or more carriers, the indication indicating sidelink beam management information associated with the one or more beams within the second frequency range, based on a mapping rule. The mapping rule may be configured by a network node, pre-configured at the first and second UEs, or pre-defined.

The method 400 includes a step 406 of adjusting, based on the sidelink beam management information, a sidelink communication associated with the one or more beams within the second frequency range. For example, the second UE may adjust the beam alignment based on the identified beam management information. The second UE may also adjust the resources to be used for transmission and/or reception based on the identified beam management information.

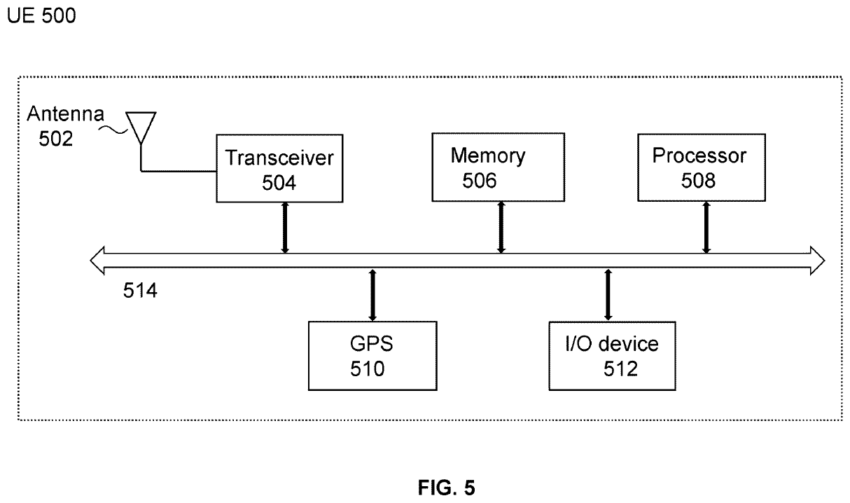

FIG. 5 is a block diagram of a UE 500, consistent with some embodiments of the present disclosure. For example, each of the Tx UE and the Rx UE in FIG. 2 may be in the form of UE 500. UE 500 may be mounted in a moving vehicle or in a fixed position. UE 500 may take any form, including but not limited to, a vehicle, a component mounted in a vehicle, a road-side unit, a laptop computer, a wireless terminal including a mobile phone, a wireless handheld device, or wireless personal device, or any other form. Referring to FIG. 5, the UE 500 may include antenna 502 that may be used for transmission or reception of electromagnetic signals to/from a base station or other UEs. The Antenna 502 may include one or more antenna elements and may enable different input-output antenna configurations, for example, multiple input multiple output (MIMO) configuration, multiple input single output (MISO) configuration, and single input multiple output (SIMO) configuration. In some embodiments, the antenna 502 may include multiple (e.g., tens or hundreds) antenna elements and may enable multi-antenna functions such as beamforming. In some embodiments, the antenna 502 is a single antenna. The antenna 502 can be an FR1 omnidirectional antenna or an FR2 antenna.

The UE 500 may include a transceiver 504 that is coupled to the antenna 502. The transceiver 504 may be a wireless transceiver at the UE 500 and may communicate bi-directionally with a base station or other UEs. For example, the transceiver 504 may receive/transmit wireless signals from/to a base station via downlink/uplink communication. The transceiver 504 may also receive/transmit wireless signals from/to another UE or road side unit via sidelink communication. The transceiver 504 may include a modem to modulate the packets and provide the modulated packets to the antenna 502 for transmission, and to demodulate packets received from the antenna 502.

The UE 500 may include a memory 506. The memory 506 may be any type of computer-readable storage medium including volatile or non-volatile memory devices, or a combination thereof. The computer-readable storage medium includes, but is not limited to, non-transitory computer storage media. A non-transitory storage medium may be accessed by a general purpose or special purpose computer. Examples of non-transitory storage medium include, but are not limited to, a portable computer diskette, a hard disk, random access memory (RAM), read-only memory (ROM), an erasable programmable read-only memory (EPROM), electrically erasable programmable ROM (EEPROM), a digital versatile disk (DVD), flash memory, compact disk (CD) ROM or other optical disk storage, magnetic disk storage or other magnetic storage devices, etc. A non-transitory medium may be used to carry or store desired program code means (e.g., instructions and/or data structures) and may be accessed by a general-purpose or special-purpose computer, or a general-purpose or special-purpose processor. In some examples, the software/program code may be transmitted from a remote source (e.g., a website, a server, etc.) using a coaxial cable, fiber optic cable, twisted pair, digital subscriber line (DSL), or wireless technologies such as infrared, radio, and microwave. In such examples, the coaxial cable, fiber optic cable, twisted pair, DSL, or wireless technologies such as infrared, radio, and microwave are within the scope of the definition of medium. Combinations of the above examples are also within the scope of computer-readable medium.

The memory 506 may store information related to identities of UE 500 and the signals and/or data received by antenna 502. The memory 506 may also store post-processing signals and/or data. The memory 506 may also store computer-readable program instructions, mathematical models, and algorithms that are used in signal processing in receiver 504 and computations in processor 508. The memory 506 may further store computer-readable program instructions for execution by processor 508 to operate UE 500 to perform various functions described in this disclosure. In some examples, the memory 506 may include a basic input/output system (BIOS) which may control basic hardware or software operation such as the interaction with peripheral components or devices. In some embodiments, the memory 506 includes both LTE SL and NR SL modules. In some embodiments, the memory 506 includes an NR SL module only. In some embodiments, the memory 506 includes an LTE SL module only.

The computer-readable program instructions of the present disclosure may be assembler instructions, instruction-set-architecture (ISA) instructions, machine instructions, machine-dependent instructions, microcode, firmware instructions, state-setting data, or source code or object code written in any combination of one or more programming languages, including an object-oriented programming language, and conventional procedural programming languages. The computer-readable program instructions may execute entirely on a computing device as a stand-alone software package, or partly on a first computing device and partly on a second computing device remote from the first computing device. In the latter scenario, the second, remote computing device may be connected to the first computing device through any type of network, including a local area network (LAN) or a wide area network (WAN).

The UE 500 may include a processor 508 that may include a hardware device with processing capabilities. The processor 508 may include at least one of a general-purpose processor, a digital signal processor (DSP), a central processing unit (CPU), a microcontroller, an application specific integrated circuit (ASIC), a field programmable gate array (FPGA), a programmable logic device, a discrete gate or transistor logic component, a discrete hardware component, or other programmable logic device. Examples of the general-purpose processor include, but are not limited to, a microprocessor, any conventional processor, a controller, a microcontroller, or a state machine. In some embodiments, the processor 508 may be implemented using a combination of devices (e.g., a combination of a DSP and a microprocessor, multiple microprocessors, one or more microprocessors in conjunction with a DSP core, or any other such configuration). The processor 508 may receive, from transceiver 504, downlink signals or sidelink signals and further process the signals. The processor 508 may also receive, from transceiver 504, data packets and further process the packets. In some embodiments, the processor 508 may be configured to operate a memory using a memory controller. In some embodiments, a memory controller may be integrated into the processor 508. The processor 508 may be configured to execute computer-readable instructions stored in a memory (e.g., the memory 506) to cause the UE 500 to perform various functions.

The UE 500 may include a global positioning system (GPS) 510. The GPS 510 may be used for enabling location-based services or other services based on a geographical position of the UE 500 and/or synchronization among UEs. The GPS 510 may receive global navigation satellite systems (GNSS) signals from a single satellite or a plurality of satellite signals via the antenna 502 and provide a geographical position of the UE 500 (e.g., coordinates of the UE 500). In some embodiments, the GPS 510 is omitted. In some embodiments, a timer is included.

The UE 500 may include an input/output (I/O) device 512 that may be used to communicate a result of signal processing and computation to a user or another device. The I/O device 512 may include a user interface including a display and an input device to transmit a user command to processor 508. The display may be configured to display a status of signal reception at the UE 500, the data stored at memory 506, a status of signal processing, and a result of computation, etc. The display may include, but is not limited to, a cathode ray tube (CRT), a liquid crystal display (LCD), a light-emitting diode (LED), a gas plasma display, a touch screen, or other image projection devices for displaying information to a user. The input device may be any type of computer hardware equipment used to receive data and control signals from a user. The input device may include, but is not limited to, a keyboard, a mouse, a scanner, a digital camera, a joystick, a trackball, cursor direction keys, a touchscreen monitor, or audio/video commanders, etc.

The UE 500 may further include a machine interface 514, such as an electrical bus that connects the transceiver 504, the memory 506, the processor 508, the GPS 510, and the I/O device 512.

In some embodiments, the UE 500 may be a transmitter UE in a sidelink communication and configured or programmed to provide sidelink beam management information. The processor 508 may be configured or programmed to execute the instructions stored in the memory 506 to configure one or more carriers within a first frequency range, at least one of the one or more carriers including an indication indicating sidelink beam management information associated with one or more beams within a second frequency range; and transmit, to a second UE, the configured one or more carriers within the first frequency range so as to allow the second UE to obtain the indication.

In some embodiments, the UE 500 may be a receiver UE in a sidelink communication and configured or programmed to receive sidelink beam management information. The processor 508 may be configured or programmed to execute the instructions stored in the memory 506 to receive, from a first UE, one or more carriers within a first frequency range, at least one of the one or more carriers including an indication indicating sidelink beam management information associated with one or more beams within a second frequency range; identify, based on the indication, the sidelink beam management information associated with the one or more beams within the second frequency range; and adjust, based on the sidelink beam management information, a sidelink communication associated with the one or more beams within the second frequency range.

As used in this disclosure, use of the term “or” in a list of items indicates an inclusive list. The list of items may be prefaced by a phrase such as “at least one of” or “one or more of.” For example, a list of at least one of A, B, or C includes A or B or C or AB (i.e., A and B) or AC or BC or ABC (i.e., A and B and C). Also, as used in this disclosure, prefacing a list of conditions with the phrase “based on” shall not be construed as “based only on” the set of conditions and rather shall be construed as “based at least in part on” the set of conditions. For example, an outcome described as “based on condition A” may be based on both a condition A and a condition B without departing from the scope of this disclosure.

In this specification, the terms “comprise,” “include,” or “contain” may be used interchangeably and have the same meaning and are to be construed as inclusive and open-ended. The terms “comprise,” “include,” or “contain” may be used before a list of elements and indicate that at least all of the listed elements within the list exist but other elements that are not in the list may also be present. For example, if A comprises B and C, both {B, C} and {B, C, D} are within the scope of A.

The present disclosure, in connection with the accompanied drawings, describes example configurations that are not representative of all the examples that may be implemented or all configurations that are within the scope of this disclosure. The term “exemplary” should not be construed as “preferred” or “advantageous compared to other examples” but rather “an illustration, an instance or an example.” By reading this disclosure, including the description of the embodiments and the drawings, it will be appreciated by a person of ordinary skills in the art that the technology disclosed herein may be implemented using alternative embodiments. The person of ordinary skill in the art would appreciate that the embodiments, or certain features of the embodiments described herein, may be combined to arrive at yet other embodiments for practicing the technology described in the present disclosure. Thus, the disclosure is not limited to the examples and designs described herein but is to be accorded the broadest scope consistent with the principles and novel features disclosed herein.

The flowcharts and block diagrams in the figures illustrate examples of the architecture, functionality, and operation of possible implementations of systems, methods, and devices according to various embodiments. It should be noted that, in some alternative implementations, the functions noted in blocks may occur out of the order noted in the figures. For example, two blocks shown in succession may, in fact, be executed substantially concurrently, or the blocks may sometimes be executed in the reverse order, depending upon the functionality involved. Likewise, additional steps may be included in such methods, and certain steps may be omitted or combined, in methods consistent with various embodiments.

It is understood that the described embodiments are not mutually exclusive, and elements, components, materials, or steps described in connection with one example embodiment may be combined with, or eliminated from, other embodiments in suitable ways to accomplish desired design objectives.

Reference herein to “some embodiments” or “some exemplary embodiments” means that a particular feature, structure, or characteristic described in connection with the embodiment can be included in at least one embodiment. The appearance of the phrases “one embodiment” “some embodiments” or “another embodiment” in various places in the present disclosure do not all necessarily refer to the same embodiment, nor are separate or alternative embodiments necessarily mutually exclusive of other embodiments.

Additionally, the articles “a” and “an” as used in the present disclosure and the appended claims should generally be construed to mean “one or more” unless specified otherwise or clear from context to be directed to a singular form.

Unless explicitly stated otherwise, each numerical value and range should be interpreted as being approximate as if the word “about” or “approximately” preceded the value of the value or range.

Although the elements in the following method claims, if any, are recited in a particular sequence, unless the claim recitations otherwise imply a particular sequence for implementing some or all of those elements, those elements are not necessarily intended to be limited to being implemented in that particular sequence.

It is appreciated that certain features of the present disclosure, which are, for clarity, described in the context of separate embodiments, may also be provided in combination in a single embodiment. Conversely, various features of the specification, which are, for brevity, described in the context of a single embodiment, may also be provided separately or in any suitable subcombination or as suitable in any other described embodiment of the specification. Certain features described in the context of various embodiments are not essential features of those embodiments, unless noted as such.

It will be further understood that various modifications, alternatives, and variations in the details, materials, and arrangements of the parts which have been described and illustrated in order to explain the nature of described embodiments may be made by those skilled in the art without departing from the scope. Accordingly, the following claims embrace all such alternatives, modifications, and variations that fall within the terms of the claims.
Clause 1. A first user equipment (UE) for providing sidelink beam management information, the first UE comprising:
a memory storing an instruction; and
a processor configured to execute the instruction stored in the memory to: configure one or more carriers within a first frequency range, at least one of the one or more carriers including an indication indicating sidelink beam management information associated with one or more beams within a second frequency range; and
transmit, to a second UE, the configured one or more carriers within the first frequency range so as to allow the second UE to obtain the indication.
Clause 2. The first UE of clause 1, wherein the first frequency range is FR1 and the second frequency range is FR2.
Clause 3. The first UE of clause 1, wherein the indication is transmitted via at least one of sidelink control information (SCI) at physical layer, media access control (MAC) control element (CE) at MAC layer, or higher layer information.
Clause 4. The first UE of clause 1, wherein the indication comprises one or more identifications (IDs) of one or more beam reference signals corresponding to the one or more beams within the second frequency range.
Clause 5. The first UE of clause 4, wherein the indication further comprises one or more resources to be used for transmission of the one or more beam reference signals, the one or more resources comprising at least one of a time resource or a frequency resource.
Clause 6. The first UE of clause 1, wherein the one or more beams are a plurality of beams to be transmitted from a plurality of different antennas, or from a plurality of different antenna panels, and wherein the indication comprises an order of transmission of at least one of the plurality of beams or the plurality of antenna panels.
Clause 7. The first UE of clause 1, wherein the indication further comprises an indication of directional beam transmission support with or without beam tuning capability.
Clause 8. The first UE of clause 4, wherein configuring the one or more carriers within the first frequency range is performed before an initial beam alignment, and the indication comprises a full list of IDs of the one or more beam reference signals, and corresponding resources to be used for transmission of the one or more beam reference signals.
Clause 9. The first UE of clause 4, wherein configuring the one or more carriers within the first frequency range is performed after an initial beam alignment, and the indication comprises a partial list of IDs of the one or more beam reference signals.
Clause 10. The first UE of clause 1, wherein the second UE is a plurality of UEs configured to operate under the second frequency range.
Clause 11. The first UE of clause 10, wherein the indication is a first indication, and the processor is further configured to execute the instruction stored in the memory to:
monitor at least one of the plurality of UEs for transmission of at least one second indication indicating sidelink beam management information; and avoid transmission of the first indication, in response to a determination that the first indication and the second indication are identical.
Clause 12. The first UE of clause 1, wherein the indication indicating sidelink beam management information is derived from one or more resources used for transmission of the one or more carriers based on a mapping rule, the mapping rule being configured, pre-configured, or pre-defined.
Clause 13. The first UE of clause 1, wherein the one or more carriers within the first frequency range are a plurality of carriers to be aggregated, and wherein each of the plurality of carriers includes a different indication indicating different sidelink beam management information.
Clause 14. The first UE of clause 1, wherein the one or more carriers within a first frequency range are a plurality of carriers to be aggregated, and wherein one or more specific carriers of the plurality of carriers include one or more indications indicating sidelink beam management information, the one or more specific carriers being configured or pre-configured.
Clause 15. The first UE of clause 1, wherein sidelink communications within the first frequency range are based on a first radio access technology (RAT) and sidelink communications within the second frequency range are based on a second RAT, the first RAT and the second RAT being the same or different from one another.
Clause 16. The first UE of clause 15, wherein the first RAT is long term evolution (LTE) and the second RAT is new radio (NR).
Clause 17. The first UE of clause 15, wherein both the first RAT and the second RAT are NR.
Clause 18. A second user equipment (UE) for receiving sidelink beam management information, the second UE comprising:
a memory storing an instruction; and
a processor configured to execute the instruction stored in the memory to: receive, from a first UE, one or more carriers within a first frequency range, at least one of the one or more carriers including an indication indicating sidelink beam management information associated with one or more beams within a second frequency range;
identify, based on the indication, the sidelink beam management information associated with the one or more beams within the second frequency range; and adjust, based on the sidelink beam management information, a sidelink communication associated with the one or more beams within the second frequency range.
Clause 19. The second UE of clause 18, wherein the first frequency range is FR1 and the second frequency range is FR2.
Clause 20. The second UE of clause 18, wherein the indication is received via at least one of sidelink control information (SCI) at physical layer, media access control (MAC) control element (CE) at MAC layer, or higher layer information.
Clause 21. The second UE of clause 18, wherein the indication comprises one or more identifications (IDs) of one or more beam reference signals corresponding to the one or more beams within the second frequency range.
Clause 22. The second UE of clause 21, wherein the indication further comprises one or more resources to be used for transmission of the one or more beam reference signals, the one or more resources comprising at least one of a time resource or a frequency resource.
Clause 23. The second UE of clause 18, wherein the one or more beams are a plurality of beams to be transmitted from a plurality of different antennas, or from a plurality of different antenna panels, and wherein the indication comprises an order of transmission of at least one of the plurality of beams or the plurality of antenna panels.
Clause 24. The second UE of clause 18, wherein the indication further comprises an indication of directional beam transmission support with or without beam tuning capability.
Clause 25. The second UE of clause 18, wherein the indication is a first indication, and the processor is further configured to execute the instruction stored in the memory to:
transmit, to the first UE, a second indication indicating sidelink beam management information, the first indication and the second indication being the same or different.
Clause 26. The second UE of clause 18, wherein, in identifying the sidelink beam management information, the processor is configured to execute the instruction stored in the memory to:
derive, from one or more resources used for transmission of the one or more carriers, the indication indicating sidelink beam management information based on a mapping rule, the mapping rule being configured, pre-configured, or pre-defined.
Clause 27. The second UE of clause 18, wherein the one or more carriers within the first frequency range are a plurality of carriers to be aggregated, and wherein each of the plurality of carriers includes a different indication indicating different sidelink beam management information.
Clause 28. The second UE of clause 18, wherein the one or more carriers within the first frequency range are a plurality of carriers to be aggregated, and wherein one or more specific carriers of the plurality of carriers include one or more indications indicating sidelink beam management information, the one or more specific carriers being configured or pre-configured.
Clause 29. The second UE of clause 18, wherein sidelink communications within the first frequency range are based on a first radio access technology (RAT) and sidelink communications within the second frequency range are based on a second RAT, the first RAT and the second RAT being the same or different from one another.
Clause 30. The second UE of clause 29, wherein the first RAT is long term evolution (LTE) and the second RAT is new radio (NR).
Clause 31. The second UE of clause 29, wherein both the first RAT and the second RAT are NR.
Clause 32. A method for providing sidelink beam management information, the method comprising:
configuring, by a first user equipment (UE), one or more carriers within a first frequency range, at least one of the one or more carriers including an indication indicating sidelink beam management information associated with one or more beams within a second frequency range; and
transmitting, to a second UE, the configured one or more carriers within the first frequency range so as to allow the second UE to obtain the indication.
Clause 33. The method of clause 32, wherein the first frequency range is FR1 and the second frequency range is FR2.
Clause 34. The method of clause 32, wherein the indication is transmitted via at least one of sidelink control information (SCI) at physical layer, media access control (MAC) control element (CE) at MAC layer, or higher layer information.
Clause 35. The method of clause 32, wherein the indication comprises one or more identifications (IDs) of one or more beam reference signals corresponding to the one or more beams within the second frequency range.
Clause 36. The method of clause 35, wherein the indication further comprises one or more resources to be used for transmission of the one or more beam reference signals, the one or more resources comprising at least one of a time resource or a frequency resource.
Clause 37. The method of clause 32, wherein the one or more beams are a plurality of beams to be transmitted from a plurality of different antennas, or from a plurality of different antenna panels, and wherein the indication comprises an order of transmission of at least one of the plurality of beams or the plurality of antenna panels.
Clause 38. The method of clause 32, wherein the indication further comprises an indication of directional beam transmission support with or without beam tuning capability.
Clause 39. The method of clause 35, wherein configuring the one or more carriers within the first frequency range is performed before an initial beam alignment, and the indication comprises a full list of IDs of the one or more beam reference signals, and corresponding resources to be used for transmission of the one or more beam reference signals.
Clause 40. The method of clause 35, wherein configuring the one or more carriers within the first frequency range is performed after an initial beam alignment, and the indication comprises a partial list of IDs of the one or more beam reference signals.
Clause 41. The method of clause 32, wherein the second UE is a plurality of UEs configured to operate under the second frequency range.
Clause 42. The method of clause 41, wherein the indication is a first indication, and the method further comprises:
monitoring at least one of the plurality of UEs for transmission of at least one second indication indicating sidelink beam management information; and avoiding transmission of the first indication, in response to a determination that the first indication and the second indication are identical.
Clause 43. The method of clause 32, wherein the indication indicating sidelink beam management information is derived from one or more resources used for transmission of the one or more carriers based on a mapping rule, the mapping rule being configured, pre-configured, or pre-defined.
Clause 44. The method of clause 32, wherein the one or more carriers within the first frequency range are a plurality of carriers to be aggregated, and wherein each of the plurality of carriers includes a different indication indicating different sidelink beam management information.
Clause 45. The method of clause 32, wherein the one or more carriers within a first frequency range are a plurality of carriers to be aggregated, and wherein one or more specific carriers of the plurality of carriers include one or more indications indicating sidelink beam management information, the one or more specific carriers being configured or pre-configured.
Clause 46. The method of clause 32, wherein sidelink communications within the first frequency range are based on a first radio access technology (RAT) and sidelink communications within the second frequency range are based on a second RAT, the first RAT and the second RAT being the same or different from one another.
Clause 47. The method of clause 46, wherein the first RAT is long term evolution (LTE) and the second RAT is new radio (NR).
Clause 48. The method of clause 46, wherein both the first RAT and the second RAT are NR.
Clause 49. A method for receiving sidelink beam management information, the method comprising:
receiving, by a second user equipment (UE), from a first UE, one or more carriers within a first frequency range, at least one of the one or more carriers including an indication indicating sidelink beam management information associated with one or more beams within a second frequency range;
identifying, by the second UE, based on the indication, the sidelink beam management information associated with the one or more beams within the second frequency range; and
adjusting, based on the sidelink beam management information, a sidelink communication associated with the one or more beams within the second frequency range.
Clause 50. The method of clause 49, wherein the first frequency range is FR1 and the second frequency range is FR2.
Clause 51. The method of clause 49, wherein the indication is received via at least one of sidelink control information (SCI) at physical layer, media access control (MAC) control element (CE) at MAC layer, or higher layer information.
Clause 52. The method of clause 49, wherein the indication comprises one or more identifications (IDs) of one or more beam reference signals corresponding to the one or more beams within the second frequency range.
Clause 53. The method of clause 52, wherein the indication further comprises one or more resources to be used for transmission of the one or more beam reference signals, the one or more resources comprising at least one of a time resource or a frequency resource.
Clause 54. The method of clause 49, wherein the one or more beams are a plurality of beams to be transmitted from a plurality of different antennas, or from a plurality of different antenna panels, and wherein the indication comprises an order of transmission of at least one of the plurality of beams or the plurality of antenna panels.
Clause 55. The method of clause 49, wherein the indication further comprises an indication of directional beam transmission support with or without beam tuning capability.
Clause 56. The method of clause 49, wherein the indication is a first indication, and the method further comprises:
transmitting, to the first UE, a second indication indicating sidelink beam management information, the first indication and the second indication being the same or different.
Clause 57. The method of clause 49, wherein, identifying the sidelink beam management information further comprises:
deriving, from one or more resources used for transmission of the one or more carriers, the indication indicating sidelink beam management information based on a mapping rule, the mapping rule being configured, pre-configured, or pre-defined.
Clause 58. The method of clause 49, wherein the one or more carriers within the first frequency range are a plurality of carriers to be aggregated, and wherein each of the plurality of carriers includes a different indication indicating different sidelink beam management information.
Clause 59. The method of clause 49, wherein the one or more carriers within the first frequency range are a plurality of carriers to be aggregated, and wherein one or more specific carriers of the plurality of carriers include one or more indications indicating sidelink beam management information, the one or more specific carriers being configured or pre-configured.
Clause 60. The method of clause 49, wherein sidelink communications within the first frequency range are based on a first radio access technology (RAT) and sidelink communications within the second frequency range are based on a second RAT, the first RAT and the second RAT being the same or different from one another.
Clause 61. The method of clause 60, wherein the first RAT is long term evolution (LTE) and the second RAT is new radio (NR).
Clause 62. The method of clause 60, wherein both the first RAT and the second RAT are NR.
Clause 63. A non-transitory computer-readable medium storing instructions that are executable by one or more processors of a first user equipment (UE) in a sidelink communication network, to perform a method, the method comprising: configuring one or more carriers within a first frequency range, at least one of the one or more carriers including an indication indicating sidelink beam management information associated with one or more beams within a second frequency range; and
transmitting, to a second UE, the configured one or more carriers within the first frequency range so as to allow the second UE to obtain the indication.
Clause 64. A non-transitory computer-readable medium storing instructions that are executable by one or more processors of a second user equipment (UE) in a sidelink communication, to perform a method, the method comprising:
receiving, from a first UE, one or more carriers within a first frequency range, at least one of the one or more carriers including an indication indicating sidelink beam management information associated with one or more beams within a second frequency range;
identifying, based on the indication, the sidelink beam management information associated with the one or more beams within the second frequency range; and adjusting, based on the sidelink beam management information, a sidelink communication associated with the one or more beams within the second frequency range.

1. A first user equipment (UE) for providing sidelink beam management information, the first UE comprising:
a memory storing an instruction; and
a processor configured to execute the instruction stored in the memory to:
configure one or more carriers within a first frequency range, at least one of the one or more carriers including an indication indicating sidelink beam management information associated with one or more beams within a second frequency range; and
transmit, to a second UE, the configured one or more carriers within the first frequency range so as to allow the second UE to obtain the indication.

2. The first UE of claim 1, wherein the first frequency range is FR1 and the second frequency range is FR2.

3. The first UE of claim 1, wherein the indication is transmitted via at least one of sidelink control information (SCI) at physical layer, media access control (MAC) control element (CE) at MAC layer, or higher layer information.

4. The first UE of claim 1, wherein the indication comprises one or more identifications (IDs) of one or more beam reference signals corresponding to the one or more beams within the second frequency range.

5. The first UE of claim 4, wherein the indication further comprises one or more resources to be used for transmission of the one or more beam reference signals, the one or more resources comprising at least one of a time resource or a frequency resource.

6. The first UE of claim 1, wherein the one or more beams are a plurality of beams to be transmitted from a plurality of different antennas, or from a plurality of different antenna panels, and wherein the indication comprises an order of transmission of at least one of the plurality of beams or the plurality of antenna panels.

7. The first UE of claim 1, wherein the indication further comprises an indication of directional beam transmission support with or without beam tuning capability.

8. The first UE of claim 4, wherein configuring the one or more carriers within the first frequency range is performed before an initial beam alignment, and the indication comprises a full list of IDs of the one or more beam reference signals, and corresponding resources to be used for transmission of the one or more beam reference signals.

9. The first UE of claim 4, wherein configuring the one or more carriers within the first frequency range is performed after an initial beam alignment, and the indication comprises a partial list of IDs of the one or more beam reference signals.

10. The first UE of claim 1, wherein the second UE is a plurality of UEs configured to operate under the second frequency range.

11. The first UE of claim 10, wherein the indication is a first indication, and the processor is further configured to execute the instruction stored in the memory to:
monitor at least one of the plurality of UEs for transmission of at least one second indication indicating sidelink beam management information; and
avoid transmission of the first indication, in response to a determination that the first indication and the second indication are identical.

12. The first UE of claim 1, wherein the indication indicating sidelink beam management information is derived from one or more resources used for transmission of the one or more carriers based on a mapping rule, the mapping rule being configured, pre-configured, or pre-defined.

13. The first UE of claim 1, wherein the one or more carriers within the first frequency range are a plurality of carriers to be aggregated, and wherein each of the plurality of carriers includes a different indication indicating different sidelink beam management information.

14. The first UE of claim 1, wherein the one or more carriers within a first frequency range are a plurality of carriers to be aggregated, and wherein one or more specific carriers of the plurality of carriers include one or more indications indicating sidelink beam management information, the one or more specific carriers being configured or pre-configured.

15. The first UE of claim 1, wherein sidelink communications within the first frequency range are based on a first radio access technology (RAT) and sidelink communications within the second frequency range are based on a second RAT, the first RAT and the second RAT being the same or different from one another.

16. The first UE of claim 15, wherein the first RAT is long term evolution (LTE) and the second RAT is new radio (NR).

17. The first UE of claim 15, wherein both the first RAT and the second RAT are NR.

18. A second user equipment (UE) for receiving sidelink beam management information, the second UE comprising:
a memory storing an instruction; and
a processor configured to execute the instruction stored in the memory to:
receive, from a first UE, one or more carriers within a first frequency range, at least one of the one or more carriers including an indication indicating sidelink beam management information associated with one or more beams within a second frequency range;
identify, based on the indication, the sidelink beam management information associated with the one or more beams within the second frequency range; and
adjust, based on the sidelink beam management information, a sidelink communication associated with the one or more beams within the second frequency range.

19. The second UE of claim 18, wherein the indication is a first indication, and the processor is further configured to execute the instruction stored in the memory to:
transmit, to the first UE, a second indication indicating sidelink beam management information, the first indication and the second indication being the same or different.

20. A method for providing sidelink beam management information, the method comprising:
configuring, by a first user equipment (UE), one or more carriers within a first frequency range, at least one of the one or more carriers including an indication indicating sidelink beam management information associated with one or more beams within a second frequency range; and
transmitting, to a second UE, the configured one or more carriers within the first frequency range so as to allow the second UE to obtain the indication.
